(19) United States
(12) Patent Application Publication
(10) Pub. No.: US 2013/0204655 A1
(43) Pub. Date: Aug. 8, 2013

(54) SYSTEM AND METHOD FOR CUSTOMIZING AND MANUFACTURING TIRES NEAR POINT-OF-SALE

(71) Applicant: Scott Damon, Brentwood, TN (US)

(72) Inventor: Scott Damon, Brentwood, TN (US)

(21) Appl. No.: 13/757,760

(22) Filed: Feb. 2, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. G06Q 30/06

(52) U.S. Cl. CPC G06Q 30/0621
USPC 705/7.25

(57) ABSTRACT

A method for producing customized tires includes providing, at a location near the point-of-sale, a set of tire casings manufactured without tire treads and a set of tire treads manufactured without tire casings. A tire that is customized to the customer is built upon demand at the location near the point-of-sale and installed at or near the time of building upon demand by the customer.

### CROSS-REFERENCE TO RELATED APPLICATIONS

This patent application claims the benefit of priority to:
(1) U.S. Provisional Patent Application No. 61/595,969, filed on Feb. 7, 2012, and entitled “System and Method for Decentralized Manufacture of New Tires Enabling Improved Performance Characteristics”;
(2) U.S. Provisional Patent Application No. 61/595,980, filed on Feb. 7, 2012, and entitled “System and Method for Customizing Vehicle Tires on Demand at Point-of-Sale”;
(3) U.S. Provisional Patent Application No. 61/595,985, filed on Feb. 7, 2012, and entitled “System and Method for Reducing Point-of-Sale Tire Inventory”;
(4) U.S. Provisional Patent Application No. 61/595,987, filed on Feb. 7, 2012, and entitled “System and Method for Tracking Inventory of Tire Components at Point-of-Sale Facility”;
(5) U.S. Provisional Patent Application No. 61/595,990, filed on Feb. 7, 2012, and entitled “System and Method for Pricing, Leasing and Transferring Ownership of Tires”; and
(6) U.S. Provisional Patent Application No. 61/595,997, filed on Feb. 7, 2012, and entitled “System and Method for Customizing and Manufacturing Tires Near Point-of-Sale,”
   which are incorporated in their entireties herein by this reference.

This application claims the benefit of priority to U.S. Provisional Patent Application No. 61/595,997, which was filed on Feb. 7, 2012, and entitled, System and Method for Customizing and Manufacturing Tires Near Point-of-Sale,” which is incorporated in its entirety herein by this reference.

### BACKGROUND OF THE INVENTION

Tire manufacturing is a laborious and time-consuming process that is typically conducted at dedicated manufacturing facilities. Such facilities have extensive manufacturing equipment specifically configured to produce tires. A typical tire is made by assembling various materials into a so-called preform. Preforms are made of natural or synthetic rubber that is layered with other materials such as steel or fiber belts, meshes, and the like. Typical newly-manufactured tires are made in a single molding and press operation. The casing of such a tire can include an inner liner, a body ply, the sidewalls, beads, apex, belt package, and other structures. The tread of such a tire can include a thick belt that is wrapped around and molded along with the casing. The combination preform is then put into a mold and heated to provide a desired shape and finish to the tire, as well as to allow the rubber to undergo a vulcanization process. Optionally, the preform may be first placed into a forming mold before being transferred to a heated, curing mold. The particular surface characteristics of the tire, such as the tread pattern, are imparted into the preform during the molding stages. During service, the tread portion becomes worn, thus necessitating that the tire be replaced or reconditioned.

The materials used to manufacture new tires have a finite shelf life in the retail environment. An inventory of tires kept in unfavorable environmental conditions, such as high heat and low humidity, for example, may adversely affect the quality of the tires. As a result, a tire manufacturer or retailer may frequently sell off tire inventory at reduced prices, often at little to no profit. Products that cannot be sold at a discount are typically discarded and/or recycled. Such waste is costly and increases the cost of goods sold for manufacturers.

As a result of such long standing circumstances, there has been a long standing need to improve the manner in which new tires are manufactured and made available to customers. In many circumstances, typical manufacturing systems are inefficient and fail to provide optimized product to customers. In this manner, such typical systems are flawed and in need of improvement.

### SUMMARY OF THE DISCLOSURE

In one embodiment, a system for near-point-of-sale manufacturing of tires is described. An original equipment manufacturing (OEM) facility of automotive tires is configured to produce new tire components. The components include a plurality of different types of tire casings and a plurality of different types of tire treads. At least one dealer tire manufacturing facility is included.

Each dealer tire manufacturing facility is configured to maintain a tire casing inventory of the plurality of different types of tire casings and a tire tread inventory of the plurality of different types of tire treads. Each dealer tire manufacturing facility includes tire building equipment adapted to combine certain types of tire casings with certain types of tire treads to produce new finished tires. For each dealer tire manufacturing facility, at least one retail outlet is associated with that dealer tire manufacturing facility and is located within a predetermined distance from the associated dealer tire manufacturing facility.

A manufacturing and inventory system informationally interconnects the OEM facility, each dealer tire manufacturing facility, and each retail outlet via a communication network. The manufacturing and inventory system includes a physical computer-readable medium including a manufacturing application comprising computer-executable instructions and a processor adapted to execute the manufacturing application. The manufacturing application is adapted to: (1) in response to receiving a customer order for a tire from at least one retail outlet, parse the customer order into manufacturing information including a particular casing and a particular tread to produce the tire, and (2) provide the manufacturing information to the associated dealer tire manufacturing facility for manufacturing the customized tire using the tire building equipment.

In another embodiment, a method for producing new tires near a point-of-sale to a customer is described. Various tire models are presented for selection to the customer at a point of sale. A customer selection for a particular tire model is received at the point of sale. In response to the customer selection, an order for the particular tire model is placed to a dealer tire manufacturing facility. Parts from an inventory at the dealer tire manufacturing facility are pulled in response to the order. The parts pulled include a particular tire casing and a particular tire tread. A finished tire is assembled from the particular tire casing and the particular tire tread which corresponds to the particular tire model. The finished tire is delivered to the point-of-sale or a location selected by the customer.

In still another embodiment, a method for near-point-to-sale manufacturing of tires is described. An original equipment manufacturing (OEM) facility of automotive tires is operated to manufacture and provide components of new tires that are only partially manufactured. The components include a plurality of different types of tire casings and a plurality of different types of tire treads. A plurality of dealer tire manufacturing facilities is operated. Each dealer tire manufacturing facility is configured to receive the partially-manufactured new tire components from the OEM facility and to assemble the same into finished tires. A network of retail outlets is maintained. Each retail outlet is associated with at least one of the plurality of tire dealer facilities.

A plurality of transport channels is used for communicating tire products between the OEM facility, the plurality of tire dealer facilities and the network of retail outlets. A manufacturing and inventory system is used that informationally interconnects the OEM facility, the plurality of tire dealer facilities, the network of retail outlets, and the plurality of transport channels, such that: a tire order received by a customer is processed through one of the network of retail outlets, said tire order being for a particular tire model that combines a selected one of the different types of tire casings and a selected one of the plurality of different types of tire treads, and a build order is provided to the dealer tire manufacturing facility such that the particular tire model can be built and shipped to the retail outlet or to a location selected by the customer.

Further and alternative aspects and features of the disclosed principles will be appreciated from the following detailed description and the accompanying drawings. As will be appreciated, the principles related to systems and methods for customizing and manufacturing tires near the point-of-sale disclosed herein are capable of being carried out in other and different embodiments, and capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a schematic view of an embodiment of a system for the near-point-of-sale manufacturing of tires in accordance with principles of the present disclosure.

FIG. 2 is a schematic view of an embodiment of a system for the near-point-of-sale customization of tires in accordance with principles of the present disclosure.

FIG. 3 is a schematic view of an embodiment of a system and method for the near-point-of-sale customization and manufacturing of tires in accordance with principles of the present disclosure.

FIG. 4 is a flowchart illustrating steps of an embodiment of an order placement and fulfillment method in accordance with principles of the present disclosure.

### DETAILED DESCRIPTION OF PREFERRED EMBODIMENTS

In an exemplary embodiment, a method is provided for producing build-your-own customized tires that are built and installed to emphasize certain enhanced performance characteristics of the tires. The method includes providing, at a location near the point-of-sale, a set of tire casings manufactured through at least partial curing and vulcanization without tire treads to provide enhanced performance characteristics such as improved rolling resistance. Such enhancement is facilitated by separately manufacturing, through at least partial curing and vulcanization, the tire casings from the tire treads. A set of tire treads manufactured through at least partial curing and vulcanization without tire casings are also provided at a location near the point-of-sale. The tire treads provide enhanced performance characteristics such as tire tread wear and wet resistance, which are facilitated by separately manufacturing the tire treads from the tire casings. A tire that is customized to the customer is built upon demand at the location near the point-of-sale, and installed at or near the time of building upon demand by the customer.

In another embodiment, the disclosure describes a method for producing new tires near the point-of-sale to a customer. The method includes manufacturing a plurality of different types of tire casings at an original equipment manufacturing (OEM) facility such that each different type of tire casing has particular performance characteristics and a peripheral base surface that has a customizable thickness, which is adapted to later receive variable dimension and performance treads thereon. A plurality of different types of treads are also manufactured at the OEM facility. Each of the different types of treads has particular performance characteristics such that one or more different types of treads are combinable with one or more different types of casings to produce a plurality of different types of tires. The pluralities of different types of casings and treads are shipped to one or more dealer facilities. Each dealer facility has equipment for assembling and finishing tires. Each dealer facility further has a network of retail channels associated therewith. An order specifying a custom tire that is selected from the plurality of different types of tires is accepted at one of the retail channels of the one or more dealer facilities. In response to the order, the custom tire is assembled using a corresponding one of the plurality of different types of tire casings and a corresponding one of the plurality of different types of treads. The custom tire is then finished using the equipment for assembling and finishing tires at the dealer facility.

In another exemplary embodiment, the disclosure describes a system for near point-of-sale customization and manufacturing of tires. The system includes a central manufacturing facility configured to produce a plurality of different casings and a plurality of different treads, wherein certain tire casings are combinable with certain treads to produce finished tires having customizable performance characteristics. The system further includes at least one dealer facility configured to maintain inventories of the pluralities of different casings and treads. Each dealer facility is associated with at least one retail channel. At least one retail facility is associated with the at least one dealer facility and is configured to be a point-of-sale for customized tires that is located near or within about 50 miles from the corresponding dealer facility. The dealer facility includes manufacturing equipment for finishing tires. A computer system associated with the central manufacturing facility, the dealer facilities, and the retail facilities includes tangible storage media containing an application having computer executable instructions for receiving a customer order for the customized tire, for parsing the customer order into manufacturing information including a particular casing and a particular tread that can be used to produce the customized tire, and for providing the manufacturing information to the corresponding dealer facility for manufacturing the customized tire using the manufacturing equipment.

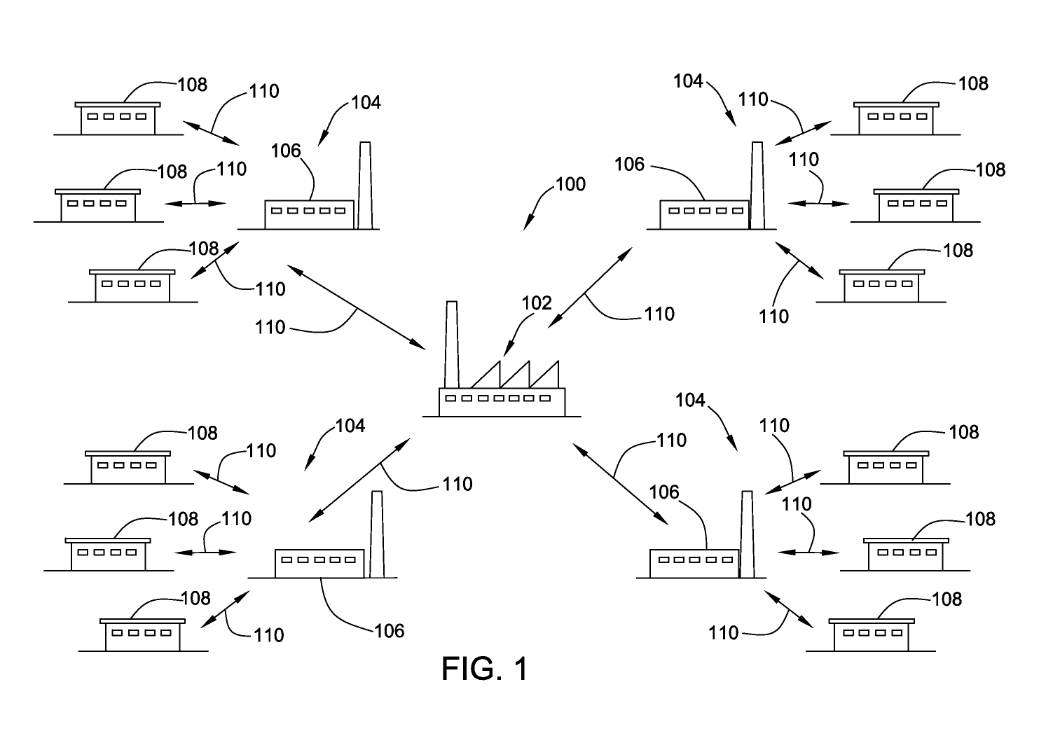

A block diagram illustrating an embodiment of a system 100 for the near-point-to-sale manufacturing of tires in accordance with principles of the present disclosure is shown in FIG. 1. The system 100 includes an original equipment manufacturer (OEM) 102 of automotive tires, such as for passenger automobiles, trucks, earth-working equipment and the like. The OEM 102 cooperates with dealers 104, which have installations in various geographical areas. The dealers 104 may be subsidiary entities to the OEM 102 or may alternatively be franchisees of the OEM 102. In the illustrated embodiment, each dealer 104 includes a manufacturing facility 106 and a network of retail outlets 108, through which tires may be sold to consumers and to fleet operators.

The manufacturing facility 106 of each dealer 104 includes manufacturing equipment and equipment configured to service, recondition, or recycle tires brought to the retail outlet 108 by consumers. Shipment of new and used tires between the retail outlets 108 and/or their respective dealer manufacturing facility 106 and/or the OEM 102 is conducted through transport channels 110, which are represented as arrows in FIG. 1 and can include various modes of shipment such as trucking or other cargo transport. Moreover, the channels 110 are representative of communication channels for exchanging product information between the retail outlets 108, dealer manufacturing facilities 106, and/or the OEM 102. Types of information that is exchanged therebetween may include inventory, sales, order, billing, and other information related to the customers and the products sold.

Although a certain number of dealers 104 having a certain number of manufacturing facilities and retail outlets are shown in FIG. 1, any other number of such entities can be used in other embodiments. For example, a dealer 104 can include more than one or no manufacturing facilities and/or more or fewer than three retail outlets. Moreover, even though the retail outlets 108 are shown as brick-and-mortar stores, they may alternatively be integrated as part of a larger store or may alternatively or additionally be an online seller of products which are shipped to the purchaser directly from a warehouse or directly from the manufacturing facility 106.

Although the system 100 can be adapted to handle new and reconditioned tires, aspects thereof relating to the manufacture of new tires will be described in further detail hereinafter. Accordingly, where in a traditional system multiple different models of new tires are manufactured at the OEM 102 and distributed to the dealers 104 for sale, in the system 100, components of new tires are only partially manufactured at the OEM 102 to allow full customization and final manufacture of the various tire models to be completed at the dealer 104.

In the system 100, casings and treads are made separately at the OEM 102 without joining the two sub-assemblies to form a finished tire. In this way, various performance characteristics of the casing and/or the tread, which can involve curing each at a different temperature to achieve different properties, which was previously unattainable, can be achieved. The OEM 102 may manufacture more than one type or model of casing and more than one type or model of tread. In addition, the OEM 102 may manufacture the casing at an OEM 102 facility that is separate from the OEM 102 facility where the tread is manufactured. Each of the casings and treads may possess different characteristics than the others. For example, different casings may have different types and amounts of strengthening structures, such as steel or fabric belts, and may be made of materials such as rubber having different rolling stiffness characteristics, thicknesses, compositions, and the like. Similarly, the various treads may be made from different materials, have different lug patterns, and so forth. In the system 100, the finishing operations to combine a particular casing with a particular tread is not completed at the OEM 102. Rather, the various casings and treads or, in general, various tire sub-assemblies and components used to assemble a finished tire, are shipped to the various dealers 104 from the OEM 102.

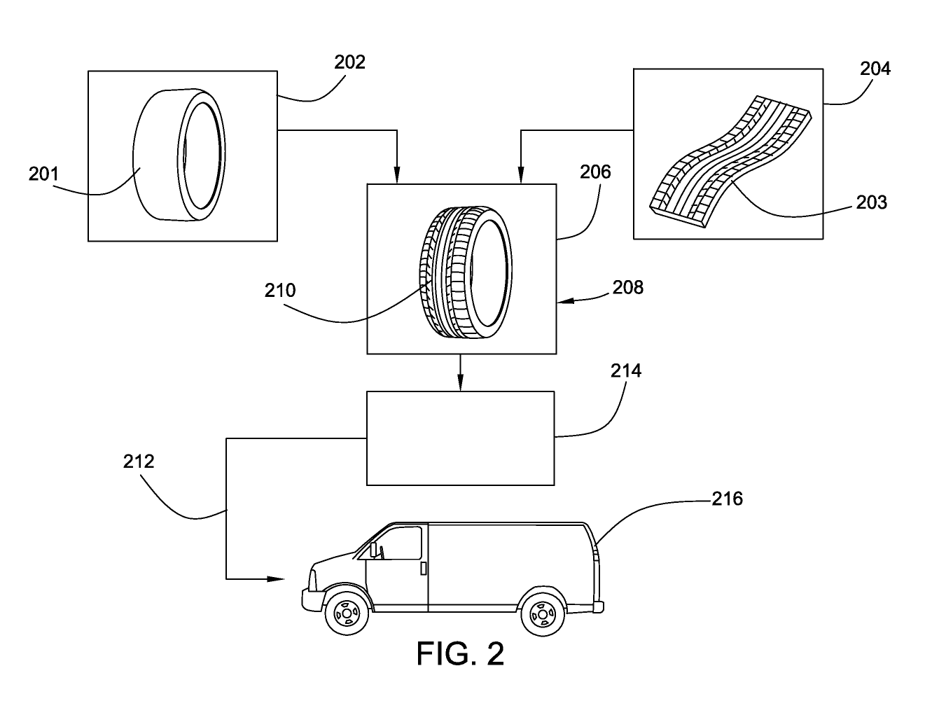

A block diagram of a tire finishing system 200 for the near-point-of-sale customization of tires is shown in FIG. 2. In the illustrated embodiment, the structures and methods associated with the tire finishing system 200 are present at each of the dealer manufacturing facilities 106 (FIG. 1). The tire finishing system 200 includes an inventory 202 of tire casings 201 and an inventory 204 of treads 203. The inventories 202, 204 of tire casings 201 and treads 203 are stocked with treads and casings made at the OEM 102 and shipped to the dealers 104 under particular casing and tread model numbers. Model number, as used herein, is meant to refer to a particular identifier used by the OEM to characterize each type of casing and tread. The model numbers may further include additional information such as the date and location of manufacture of each casing 201 or tread 203. Each inventory 202, 204 of tire casings 201 and treads 203 is stocked with more than one model number of casing 201 and more than one type of tread 203, which can be combined to produce more than one model of tire. The inventories 202, 204 of tire casings 201 and treads 203 are maintained on-site at the facility of each dealer 104 such that parts to fill orders for tires are always on hand.

The tire finishing system 200 further includes a tire building department 206. The tire building department 206 may include various machines and skilled technicians that can put together a tire preform using casings and treads pulled from the inventories 202, 204 of tire casings 201 and treads 203. In the illustrated embodiment, the tire building department 206 functions in response to orders that are provided through an order channel 208. The order channel 208 may provide to the tire building department 206 information about tire orders to be fulfilled, which can include the number of tires to be manufactured as well as the specific model numbers for the casing and the tread that should be used to manufacture each tire.

When an order for a tire is received at the tire building department 206 via the order channel 208, the order is analyzed to determine which model number casing should be pulled from the casing inventory 202 and which model number of tread should be pulled from the tread inventory 204. Thereafter, the particular casing and tread are retrieved from their respective inventory 202, 204 either manually by a technician or by use of an automated inventory control system. The retrieved casing and tread are combined to form a tire preform 210 that is customized to the order. The processes to combine the casing with the tread may include various operations, such as buffing of the base portion of the casing to remove oxidation, deposition of cushion gum on the casing, fitting, pressing and stitching of the tread around the casing, and the like. After the tire has been assembled, it may further undergo a pressing and vulcanization operation to complete the tire. The tire preform 210 is transformed into a finished tire 212 that is shipped to a retail location 108, for example, by a regional shipper 216, after undergoing a forming and curing operation at a vulcanization press 214. In the illustrated embodiment, it is contemplated that the vulcanization press 214 can be sufficiently sized to handle the product throughput of each dealer, and can thus be sized to accommodate a batch of as few as one tire and as many as thirty tires, for example, at any one time.

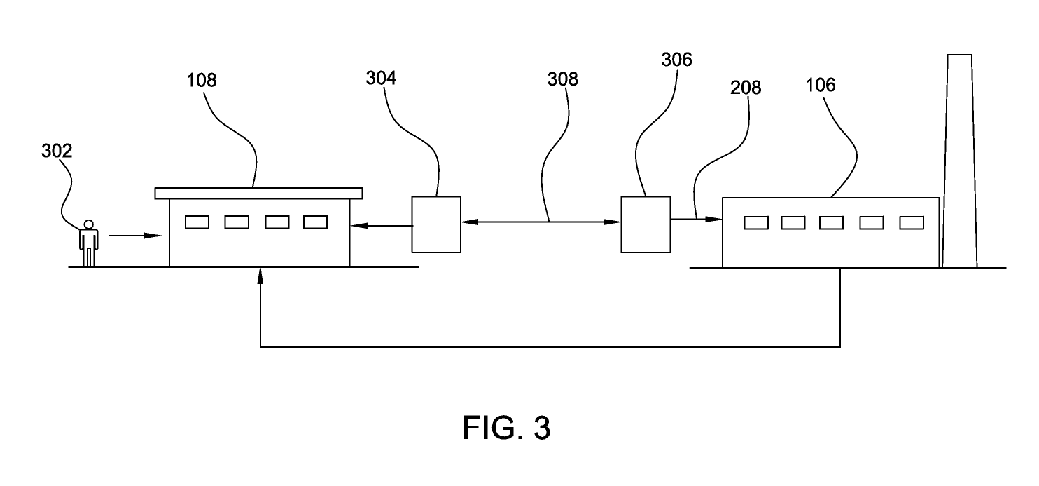

A block diagram illustrating a system and method for near-point-of-sale customization and manufacturing of tires is shown in FIG. 3. The manufacturing process for a customized tire begins when an order for a tire is placed at a retail location 108 or is otherwise provided to the dealer, for example, through the Internet. In the illustrated exemplary embodiment, a customer 302 can visit the retail location 108, where skilled customer service representatives can aid the customer 302 in selecting a model of tire having performance characteristics under various parameters that are best suited for the customer's particular needs. Such performance characteristics may be, for example, the tire's rolling resistance, wear resistance, traction capability under different weather and climate conditions, speed rating, drive-surface-specific features, and others.

After the customer 302 has selected the desired number and type of tires to be purchased, the sales associate can enter the customer's order into an automated ordering system 304 installed at the retail location 108. The automated ordering system 304 can include a computer system having a processor and tangible storage media having stored thereon computer executable instructions, which are accessible by the processor and at least partially modifiable or configurable by user input and output devices, such as computer terminals. Accordingly, the sales associate can enter the customer's order into the ordering system 304 by providing sufficient order information that can include the type, model number and number of tires ordered by the customer 302 as well as other information such as billing or payment information, time and place of delivery of the tires, whether the customer wishes to have the tires installed into a vehicle at the retail location 108, and other information.

Information relative to the tires ordered by the customer 302 can be sent from the ordering system 304 to a manufacturing system 306 at the manufacturing facility 106 via a communication channel 308. As in the ordering system 304, the manufacturing system 306 can be configured as a computer system that includes all structures and functionality required to receive and carry out computer executable instructions that are stored on a tangible medium and that are arranged for implementing various functions of the system. As specifically related to the present disclosure, the manufacturing system 306 can execute a manufacturing application that is adapted to receive the order information from the communication channel 308, and parse that information into an identification of the number and model number of the various components that will need to be retrieved from inventory so the tire order can be fulfilled. In one embodiment, the manufacturing system 306 is adapted to carry out additional functionality and tracking such as tracking the amount of inventory such that additional material can be ordered from the OEM 102 (FIG. 1) when the inventory is reduced to a selected threshold level, for example, prioritization of tire building and finishing based on the timing information of each order, and so forth.

When the particular pull-information for casings 201 and treads 203 from the respective inventories 202, 204 of tire casings 201 and treads 203 has been compiled, the order signal 208 can be generated and sent to the tire building department 206 (FIG. 2) within the manufacturing facility 106, where a tire is built as previously described relative to FIG. 2. When the tire order has been built, the completed tires are shipped to the retail outlet 108 from the manufacturing facility 106 for delivery to the customer 302.

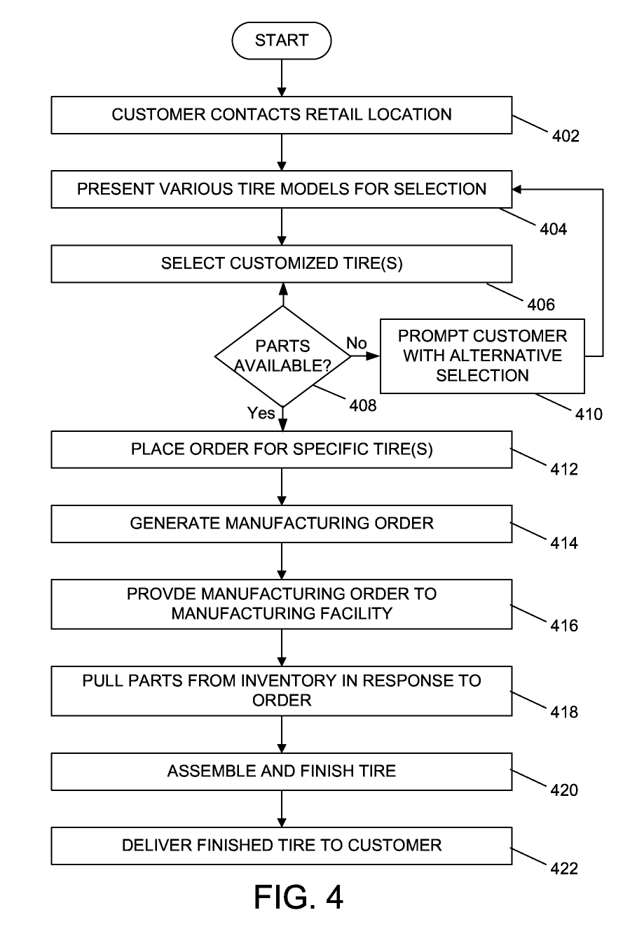

It is contemplated that the time between placement of a tire order and delivery of the finished tires to the customer can be completed rather quickly, for example, in a matter of hours. In other words, the pulling of tire components from inventory and the building of the finished tire occurring at the dealer 104 near the point-of-sale, i.e., the retail location 108, can be accomplished rather quickly and, often, while the customer 302 waits. Accordingly, a flowchart for a method of fulfilling a tire order is shown in FIG. 4.

The process begins when a customer contacts a retail location in any fashion, for example, by appearing in-person at a retail store, by visiting an Internet website, by placing a call to the retailer, by sending a facsimile order form, by using a mobile computing application, or by any other appropriate means, at process step 402. The customer is presented with an array of various tire models available at step 404, and selects a particular tire that is customized to the customer's needs at step 406. The customization of the tire, as previously discussed, can include a set of choices for the customer based upon at least one of various performance attributes of the available casing and tread options available at the dealer 104 (FIG. 1) to determine whether parts are available to build the selected tire at step 408. In the event a particular casing and tread combination is not currently available, for example, in existing inventory, the system can prompt the customer with an alternative selection that uses available parts and has performance characteristics that are equivalent or close to those originally selected by the customer at 410 and/or further inform the customer of an expected lead time for that dealer 104 to procure the necessary components to build the customer's original selection. In other embodiments, the system can perform a query over the communication channel 110 which can include a network linking a plurality of dealers 104 to find the nearest dealer, or a set of dealers within a specified range of the dealer in questions, that can fulfill the customer's original selection using in-stock tire components.

When a custom tire has been selected, the customer can place an order for a specific number of tires at step 412. Order placement by the customer at step 412 prompts a manufacturing order to be generated at step 414. The manufacturing order can include information on the specific casing and tread that will be required, as well as additional information such as the required buffing and/or other operational steps that will be required on the selected casing and tread components to produce the particular tire and so forth. The manufacturing order is generated at the point of sale to the customer, and is provided to a manufacturing facility or dealer at step 416. At the manufacturing facility, inventory is pulled in response to the manufacturing order at step 418. The inventory pulled may include a casing, tread, and any other components that may be required to form a completed tire. The selected parts are assembled into a tire preform and subjected to a forming and vulcanization process to produce a finished tire at step 420. The finished tire is then delivered to the customer at step 422, for example, by regional courier service, by mail, and/or by other methods.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for near-point-of-sale manufacturing of tires, comprising:
an original equipment manufacturing (OEM) facility of automotive tires, the OEM facility configured to produce new tire components, said components including a plurality of different types of tire casings and a plurality of different types of tire treads;
at least one dealer tire manufacturing facility, each dealer tire manufacturing facility configured to maintain a tire casing inventory of the plurality of different types of tire casings and a tire tread inventory of the plurality of different types of tire treads, and each dealer tire manufacturing facility including tire building equipment adapted to combine certain types of tire casings with certain types of tire treads to produce new finished tires;
for each dealer tire manufacturing facility, at least one retail outlet associated with said dealer tire manufacturing facility and located within a predetermined distance from the associated dealer tire manufacturing facility;
a manufacturing and inventory system that informationally interconnects the OEM facility, each dealer tire manufacturing facility, and each retail outlet via a communication network, the manufacturing and inventory system including a physical computer-readable medium including a manufacturing application comprising computer-executable instructions and a processor adapted to execute the manufacturing application;
wherein the manufacturing application is adapted to:
in response to receiving a customer order for a tire from at least one retail outlet, parse the customer order into manufacturing information including a particular casing and a particular tread to produce the tire, and
provide the manufacturing information to the associated dealer tire manufacturing facility for manufacturing the customized tire using the tire building equipment.

2. The system for near-point-of-sale manufacturing of tires of claim 1, wherein certain types of tire casings are combinable with certain types of tire treads to produce finished tires having customizable performance characteristics.

3. The system of claim 2, wherein the manufacturing application is further adapted to:
receive tire performance characteristic selections from the customer and to select the particular casing and the particular tread to produce the tire satisfying the selected tire performance characteristics, said tire performance characteristic selections being indicative of at least one of rolling resistance, wear resistance, traction capability under different weather and climate conditions, speed rating, and drive-surface-specific features of a tire.

4. The system for near-point-of-sale manufacturing of tires of claim 1, wherein the manufacturing application is further adapted to:
monitor the tire casing inventory by type at each dealer tire manufacturing facility;
monitor the tire tread inventory by type at each dealer tire manufacturing facility; and
generate and send a tire component order to the OEM facility when a particular type of tire casing or tire tread in the monitored tire casing inventory and tire tread inventory falls below a predetermined threshold.

5. The system for near-point-of-sale manufacturing of tires of claim 1, further comprising:
an ordering system having a physical computer-readable medium including a tire ordering application comprising computer-executable instructions and a processor adapted to execute the tire ordering application, the tire ordering application adapted to receive tire ordering information from a customer sufficient to generate the customer order for a tire, the ordering system accessible at each retail outlet.

6. The system for near-point-of-sale manufacturing of tires of claim 1, further comprising:
a plurality of dealer tire manufacturing facilities; and
a network of retail outlets, each retail outlet associated with at least one of the plurality of dealer tire manufacturing facilities.

7. A method for producing new tires near a point-of-sale to a customer, the method comprising:
presenting various tire models for selection to the customer at a point of sale;
receiving a customer selection for a particular tire model at the point of sale;
in response to the customer selection, placing an order for the particular tire model to a dealer tire manufacturing facility;
pulling parts from an inventory at the dealer tire manufacturing facility in response to the order, said parts including a particular tire casing and a particular tire tread;
assembling, from the particular tire casing and the particular tire tread, a finished tire corresponding to the particular tire model; and
delivering the finished tire to the point-of-sale or a location selected by the customer.

8. The method of claim 7, further comprising:
manufacturing and providing components of new tires that are only partially manufactured at an original equipment manufacturer (OEM) facility, said components including a plurality of different types of tire casings and a plurality of different types of tire treads; and
delivering the plurality of different types of tire casings and the plurality of different types of tire treads to the dealer tire manufacturing facility for storing in the inventory.

9. The method of claim 8, wherein certain types of tire casings are combinable with certain types of tire treads to produce finished tires having customizable performance characteristics.

10. The method of claim 9, further comprising:
receiving tire performance characteristic selections from the customer;
selecting the particular casing and the particular tread to produce the tire satisfying the selected tire performance characteristics, said tire performance characteristic selections being indicative of at least one of rolling resistance, wear resistance, traction capability under different weather and climate conditions, speed rating, and drive-surface-specific features of a tire.

11. The method of claim 8, further comprising:
monitoring the tire casing inventory;
monitoring the tire tread inventory; and
generating and sending a tire component order to the OEM facility when a particular type of tire casing or tire tread in the monitored tire casing inventory and tire tread inventory falls below a predetermined threshold.

12. The method of claim 7, wherein the steps between communicating with the customer and delivering the finished tire to the customer are completed in fewer than twenty-four hours.

13. A method for near-point-to-sale manufacturing of tires, comprising:
operating an original equipment manufacturing (OEM) facility of automotive tires to manufacture and provide components of new tires that are only partially manufactured, said components including a plurality of different types of tire casings and a plurality of different types of tire treads;
operating a plurality of dealer tire manufacturing facilities, each configured to receive the partially-manufactured new tire components from the OEM facility and to assemble the same into finished tires;
maintaining a network of retail outlets, each retail outlet associated with at least one of the plurality of tire dealer facilities;
using a plurality of transport channels for communicating tire products between the OEM facility, the plurality of tire dealer facilities and the network of retail outlets; and
utilizing a manufacturing and inventory system that informationally interconnects the OEM facility, the plurality of tire dealer facilities, the network of retail outlets, and the plurality of transport channels, such that:
a tire order received by a customer is processed through one of the network of retail outlets, said tire order being for a particular tire model that combines a selected one of the different types of tire casings and a selected one of the plurality of different types of tire treads, and
a build order is provided to the dealer tire manufacturing facility such that the particular tire model can be built and shipped to the retail outlet or to a location selected by the customer.

14. The method of claim 13, further comprising combining each one of the plurality of different types of tire casings with at least one of the plurality of different types of tire treads to manufacture a respective number of different tire models.

15. The method of claim 13, further comprising:
maintaining and tracking a tire casing inventory at each dealer tire manufacturing facility;
maintaining and tracking a tire tread inventory at each dealer tire manufacturing facility; and
generating and sending a tire component order to the OEM facility when the respective tire casing and tire tread inventories fall below a threshold quantity for a particular type.

16. The method of claim 13, wherein the steps between processing the tire order and shipping the particular tire model are completed in fewer than twenty-four hours.

17. The method of claim 13, further comprising:
operating the manufacturing and inventory system to exchange information with the customer and to build the tire order based on customer information, said customer information being indicative of at least one of rolling resistance, wear resistance, traction capability under different weather and climate conditions, speed rating, and drive-surface-specific features of a tire.

18. The method of claim 13, further comprising:
presenting various tire models for selection to the customer at the retail outlet.

19. The method of claim 13, further comprising:
using the manufacturing and inventory system to query the plurality of dealer tire manufacturing facilities to search for a dealer tire manufacturing facility nearest to, or within a specified range of, the retail outlet from which the tire order was received and that has the particular casing and the particular tread in inventory.

20. The method of claim 19, wherein the manufacturing and inventory system is adapted to provide the retail from which the tire order was received with an alternate tire selection if no dealer tire manufacturing facility within a specified range of the retail outlet has the particular casing and the particular tread for the tire order in inventory.
